(19) United States
(12) Patent Application Publication
(10) Pub. No.: US 2009/0016896 A1
(43) Pub. Date: Jan. 15, 2009

(54) Conical washer system for propeller stabilization

(76) Inventor: Daryl G. Hill, Yakima, WA (US)

Correspondence Address: STRATTON BALLEW, 213 S 12TH AVE, YAKIMA, WA, 98902, US

(21) Appl. No.: 12/154,452

(22) Filed: May 23, 2008

Related U.S. Application Data
(60) Provisional application No. 60/931,788, filed on May 25, 2007.

(51) Int. Cl. F03D 11/04

(52) U.S. Cl. 416/244 R

(57) ABSTRACT

A mount and conical spring element for use in a propeller stabilizer system, especially suited to stabilize the propellers of a wind machine or alternatively a wind powered generator, and more particularly a system of conical washers, or “belleville” type washers, positioned at the teeter pinned hub of the propeller, to counter a tilting action of the propeller upon the hub. The propeller stabilizer system includes a propeller assembly with a rotating hub having a plurality of propeller blades attached, and the hub mounted to a propeller shaft. The hub connects to the propeller shaft with a teeter pin, and the propeller assembly is tilt-able on the shaft, about the teeter pin. The propeller shaft also includes a washer mount for receiving a conical washer element, which abuts to both the propeller assembly and the washer mount. The conical washer element dampens the tilt of the propeller assembly upon the propeller shaft, about the teeter pin.

### TECHNICAL FIELD

The invention relates to a system employing a conical washer, especially suited to stabilize the propellers of a wind machine or alternatively a wind-powered generator, and more particularly a system of conical washers, or “belleville” type washers, positioned at the teeter-pinned hub of the propeller, to counter a tilting action of the propeller upon the hub.

### BACKGROUND OF THE INVENTION

Wind machines are increasingly employed for frost protection for agricultural applications, often to prevent springtime frost damage to a crop by circulating the air near the crop. In a wind machine a mast-mounted propeller rotates to move warmer air aloft, to raise the temperature of the crop, on the ground below. Other applications of wind machine technology are observed in propeller driven crop cooling and drying systems, odor control machines and wind power generation equipment.

For any of these propeller driven applications of wind machine technologies listed above, the connection between the rotor blades of the propeller and the rotating shaft at the top of the mast is one of the most critical areas on the entire wind machine. This interface is commonly referred to as the hub. Controlling “teeter” or tilting movement of the propeller as it rotates about the shaft, preventing the propeller from staying in its normalized plane of rotation, which is critical to the safe operation of the wind machine.

Teetering can be precisely controlled, as is often done in helicopter fan blades. Over teetering can become a problem, and lead to excessive propeller tilt, or eventual failure of the propeller shaft in extreme situations. A “teeter pivot” is a conventional mechanical element of propellers, employed in a variety of uses and configurations, which provides for the teetering of the propeller on the propeller shaft. The limited rocking or tilting action of a conventional, rigid two-bladed propeller on its shaft, is enabled by the teeter pivot, which allows a cyclic tilting action of the propeller blades on the propeller's hub.

Often, the teetering amplitude of a wind machine propeller increases with increasing propeller speed and cross winds. A certain degree of teeter is desirable, to compensate for wind and pressure differentials across the propeller. Limits to teeter are normally set by “stops,” or other mechanical barriers to tilt, typically set for approximately ten degrees, at a maximum. The safe and efficient dampening and controlling of over-teeter is a desirable goal of wind machine design and operation.

The cost, complexity, and weight of the hub are important aspects to be considered in its design for an efficient wind machine. Prior wind machines incorporate mechanisms with a significant level of complexity, in the integration of propeller connection to the hub in an attempt to control teetering. Many employ some form of passive physical controls over extreme teetering

The following is a disclosure of the present invention that will be understood by reference to the following detailed description taken in conjunction with the accompanying drawings.

### BRIEF DESCRIPTION OF DRAWINGS

FIG. 1 is a partially sectioned side view of a propeller stabilizer system, according to an embodiment of the invention;

FIG. 2 is a partially exploded perspective view of a propeller stabilizer system, according to an embodiment of the invention;

FIG. 3 is a perspective view of a propeller stabilizer system, according to an embodiment of the invention;

FIG. 4 is a side view of a propeller stabilizer system, according to an embodiment of the invention; and

FIG. 5 is a portion of front view of a propeller stabilizer system, according to an embodiment of the invention.

### DETAILED DESCRIPTION OF SPECIFIC EMBODIMENTS

The invention provides a propeller stabilizer system that includes a conical washer mount. The propeller stabilizer system is utilized with a teeter pin to counter tilting actions of the propellers upon the hub of a wind machine, or alternatively a wind-powered generator.

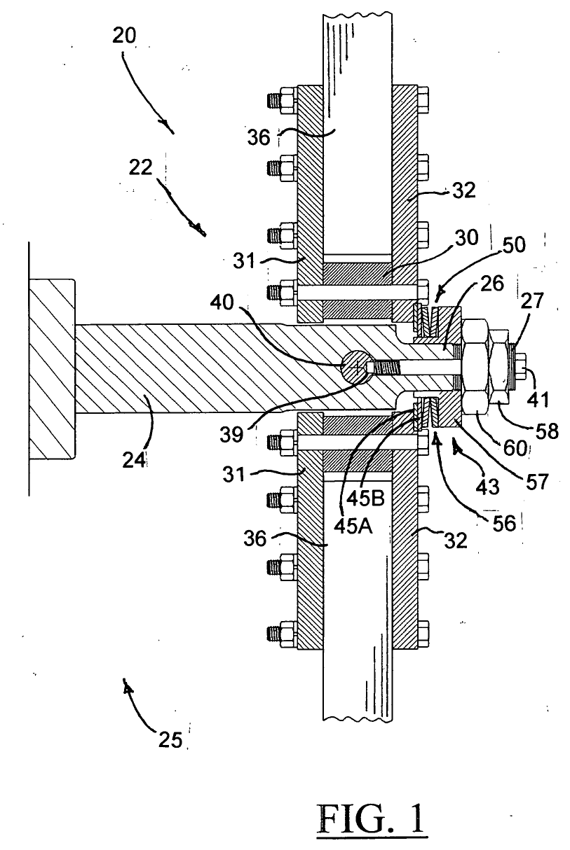

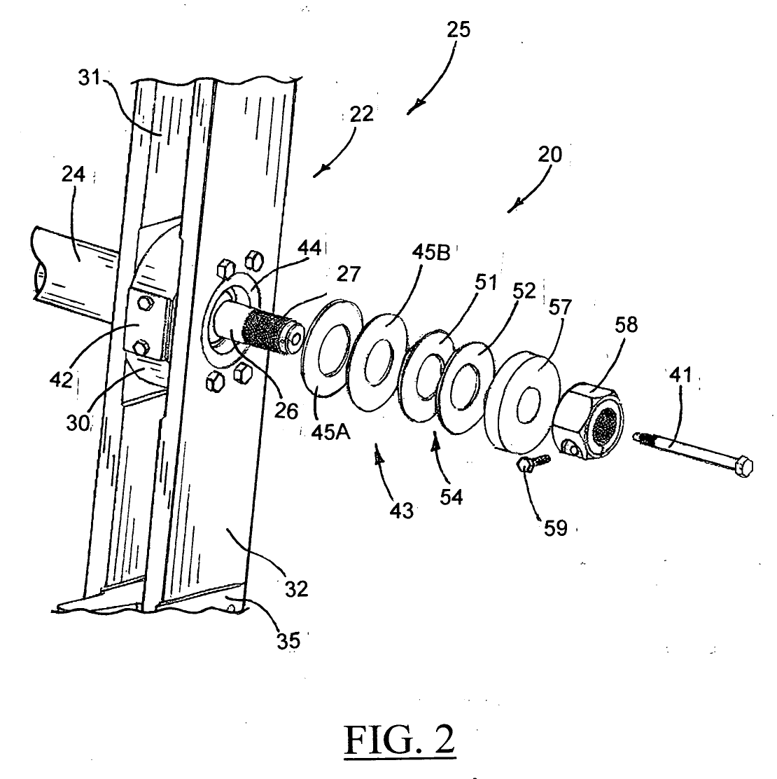

FIGS. 1 through 5 show the propeller stabilizer system 20, according to certain preferred embodiments of the present invention. The propeller stabilizer system includes a propeller assembly 22, which is mounted to a propeller shaft 24, and is especially for use with a wind machine 25. As shown in FIGS. 1 and 2, the propeller shaft terminates at a shaft nose 26, with a threaded end 27 for receiving additional elements of the propeller stabilizer system.

As shown in FIGS. 1 through 4, the propeller assembly 22 preferably includes a hub 30, which is effectively “sandwiched” between a rear splice plate 31 and a front splice plate 32. The rear splice plate and the front splice plate, with the hub between them, are received onto the shaft nose 26. The rear splice plate and the front splice plate also sandwich a propeller blade 35. Other configurations of the splice plates, hub and fan blade or a plurality of propeller blades 36 could be employed, as are known to those skilled in the design and manufacture of propeller assemblies, especially useful in wind machine fan and propeller systems.

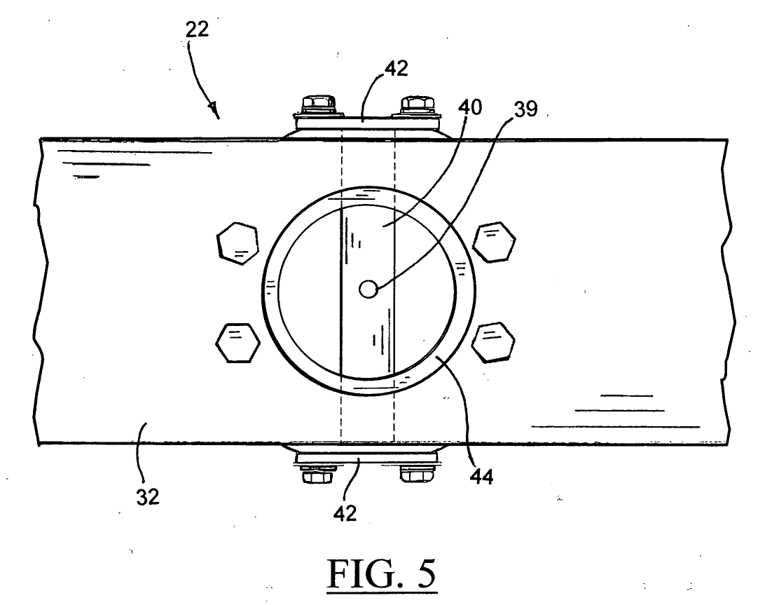

A teeter pin 40 is received through the hub 30, and penetrates the shaft nose 26 at a right angle, perpendicular to the propeller shaft 24. “Teeter” is a term commonly used to describe tilting of a propeller on a shaft, out of the plane of propeller rotation. As discussed in the background section, above, excessive teeter may lead to harmful stresses on key components of the mind machine 25, or catastrophic failures, especially if teetering is unchecked. With the aid of the teeter pin, the propeller assembly 22 has a limited freedom to tilt upon the propeller shaft. Preferably, a center keying bolt 41 engages the teeter pin at a key hole 39, holding the teeter pin in place within the hub. The center keying bolt is received into inserted into the shaft nose 26, as shown in FIGS. 1 and 2. Additionally, the two ends of the teeter pin are preferably capped, and held within the hub by a pair of hub plates 42, as shown in FIG. 5.

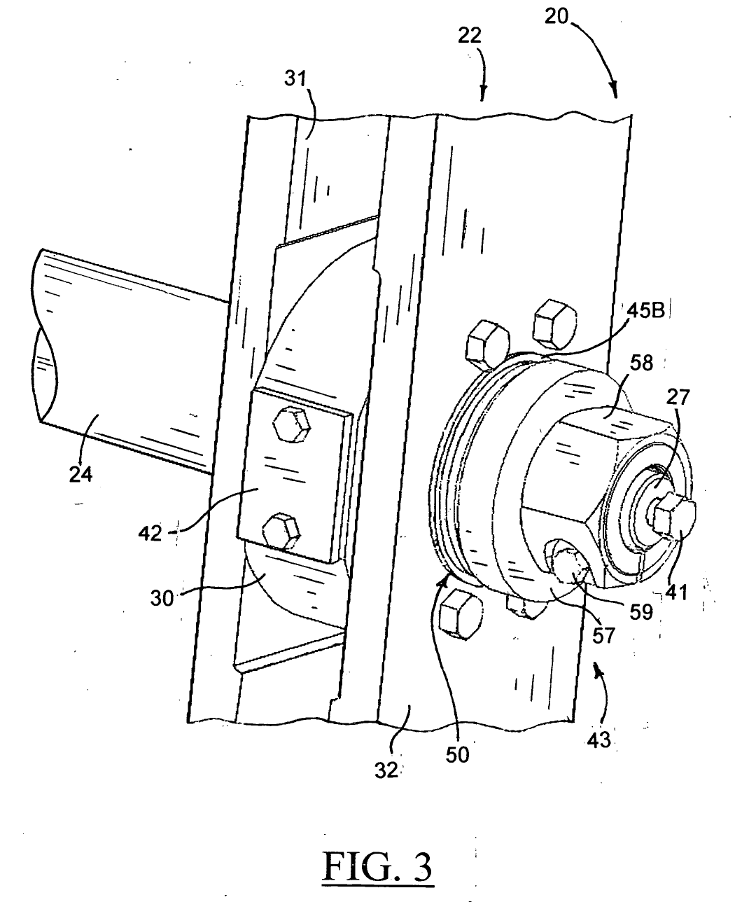

The propeller stabilizer system 20 of the present invention mechanically opposes the tendency of the propeller assembly to teeter under operational loading of the wind machine 25, as the propeller assembly spins. To dampen teeter, and forcibly limit the ease and magnitude of tilt in the propeller assembly 22, the propeller stabilizer system includes a nose assembly 43, received onto the shaft nose 26, as also shown in FIGS. 2 and 3.

The front splice plate 32 preferably includes a wear plate seat 44, which is preferably countersunk into the front slice plate, as shown in FIG. 2. The wear plate seat receives a wear plate 45A. Additionally, as is preferred, a support spacer 45B is also employed to adequately support additional elements of the nose assembly 43. Preferably, the wear plate and the support spacer are manufactured from a wear resistant metal alloy, and are both in form of a conventional flat washer. The wear plate is receivable onto the shaft nose 26, into the wear plate seat, followed by the support spacer. The wear plate and support spacer are field replaceable elements that provide a smooth and low friction surface, for the rotating element of the nose assembly 43, while preventing the wearing of the front splice plate.

A key component of the nose assembly 43 of the propeller stabilizer system 20 is a conical washer element 50 received onto the shaft nose 26, and abutted to the wear plate 45. As shown in FIG. 2, a preferred embodiment of the conical washer element includes an inner conical washer 51 and an outer conical washer 52. Both, the inner conical washer and the outer conical washer can be described and referred to as “Belleville” types of washers.

Belleville washers, also known as “cupped spring washers” and for the present invention, “conical washers,” are a well-known mechanical dampening device, with many uses. With its conical shape, the conventional Belleville washer simply provides a mechanical resistance to being flattened. Belleville washers must be properly engineered to provide the needed resistance to flattening or “deflection.” Multiple Belleville washers may be stacked to modify the amount of deflection, along with the force required to deflect the washer, termed herein as “stiffness.”

The conical washer element 50 may be a single conical washer, or as preferred, a plurality of conical washers, oriented in parallel or in series, to increase the stiffness and the deflection of a group of washers comprising the conical washer element. Specifically, when the conical washers are used in a stack oriented in the same direction, in a nested or a “parallel” orientation, the resultant effect multiplies the stiffness by approximately two-fold, the force required to deflect the conical washer element. When used in a stack, with an end-to-end or opposed orientation, referred to as a “series” orientation 54, the force required to deflect the conical washer element approximately remains the same, while the deflection is increased approximately two-fold, as compared to the single conical washer.

Conical washers, for use with the conical washer element 50, have the ability to be fine-tuned for precisely engineered spring qualities. These conical washers are conventionally employed under low dynamic loads, as they tend to “bottom out,” and develop “hysteresis” or material memory and fatigue. Additionally, conical washers, typically made from steel, preferably chemically plated for resistance to corrosion, are prone to material degradation due to friction and wear when used in rotating systems. Preferably, a corrosion resistant treatment for the washers is also employed, such as a non-electrolytic nickel or “Kanigen” plating, as is known to those skilled in protective surface treatments for metals.

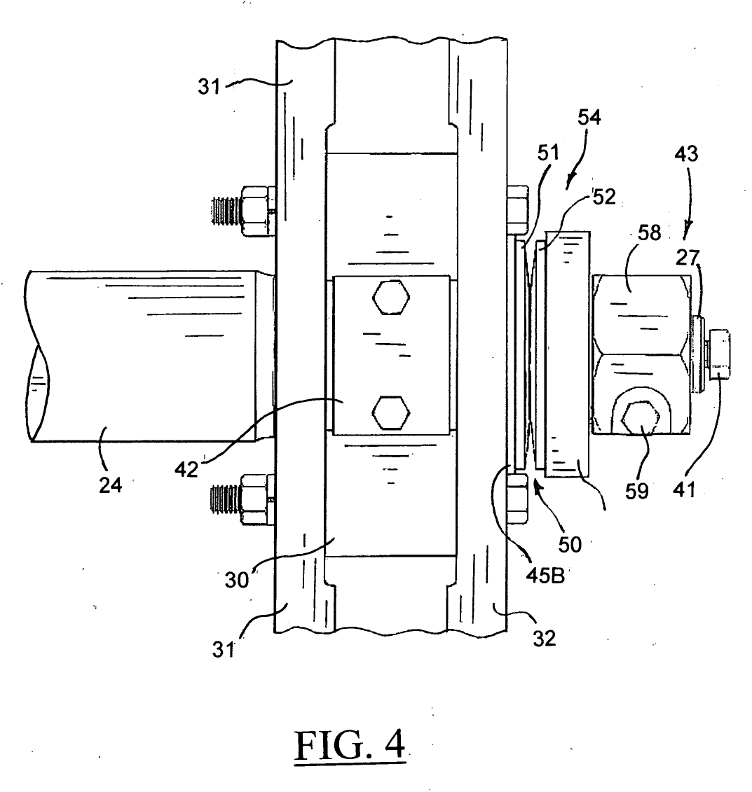

Preferably, the conical washer element 50 is uniquely selected and configured to avoid these problems and provide dynamic attenuation of propeller assembly. Most preferably, as discussed above, the series orientation 54 of two conical washers, abutted end-to-end, as shown in FIG. 4, are preferred, with the inner conical washer 51 and the outer conical washer 52 forming the conical washer element, stacked against support spacer 435B. Any configuration of conical washers, singularly, in series, in parallel, or any combination thereof, could be employed for the purposes of the present invention.

The nose assembly 43 includes the conical washer element 50 placed onto the shaft nose 26, at the terminus of the propeller shaft 24, and moved down the shaft proximate to the hub 30 of the propeller assembly 22, where the conical washer element is abutted against the wear plate 45A, as shown in FIGS. 2 and 3. The conical washer element is held in place on the propeller shaft with a washer element mount 57. The washer element mount includes a cupped shaped cavity 56 for receiving the conical washer element.

The washer element mount 57 is preferably held tight against the conical washer element 50 to “pre-tension” the conical washers of the conical washer element. Both the washer element mount and the conical washer element are received onto the propeller shaft 24, between the propeller assembly 22 and the threaded end 27 of the propeller shaft. The pre-tensioned conical washer element maintains the propeller assembly in a precisely balanced, and perpendicular position on the propeller shaft, and centered about the teeter pin 40. The pre-tensioning of the conical washer element is achieved by use of a compression lock nut that is received onto the threaded end of the propeller shaft, at the shaft nose 26.

The compression lock nut 58 is preferably a “split” nut that can receive a compression lock bolt 59, as shown in FIG. 3. Alternatively, the compression lock nut can be utilized with a counter locking nut 60, as shown in FIG. 1. The tightening of either the compression lock bolt or the counter locking nut, immovably secures the compression lock nut in place on the threaded end 27 of the propeller shaft 24. The lock bolt or the counter locking nut can be loosened and the compression lock nut can be adjusted, to increase or decrease the pre-tensioning on the conical washer element 50, or to remove the conical washer element or propeller assembly for replacement or maintenance.

The propeller stabilizer system 20 of the present invention relies on the interaction between the conical washer element 50 of the nose assembly 43, and the teeter pin 40 of the propeller assembly 22. Employed in co-operation with the teeter pin, the conical washer element serves to balance the entire propeller assembly about the teeter pin, which acts as a center balance point for the propeller assembly. The teetering action of the propeller assembly about the teeter pin balance, can be precisely “tuned” or controlled, especially with the conical washer element, when preferably pre-engineered to provide the exact range of tension and deflection needed to serve the weight and operational forces expected in any particular wind machine application.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. A propeller stabilizer system comprising:
a propeller assembly including a hub, a plurality of propeller blades attached to the hub, and the hub removably mountable to a propeller shaft;
the propeller shaft terminates at a shaft nose, and includes a washer mount proximate to the shaft nose;
the hub mounted to the propeller shaft with a teeter pin, the teeter pin penetrates the propeller shaft at a right angle through the shaft nose, perpendicular to the propeller shaft;
the propeller assembly tilt-able on the propeller shaft, about the teeter pin;
a conical washer element having an inside surface and an outside surface, the inside surface abutted to the propeller assembly and the outside surface abutted to the washer mount; and
the tilt of the propeller assembly upon the propeller shaft dampened about the teeter pin by the conical washer element.

2. The propeller stabilizer system of claim 1, wherein:
the conical washer element is received onto the shaft nose.

3. The propeller stabilizer system of claim 1, wherein:
the conical washer element includes an inner conical washer abutted to an outer conical washer.

4. The propeller stabilizer system of claim 1, wherein:
the conical washer element includes a multiple of conical washers.

5. The propeller stabilizer system of claim 1, wherein:
the propeller system is a included in a wind machine.

6. The propeller stabilizer system of claim 1, wherein:
the conical washer element mechanically opposes the tendency of the propeller assembly to teeter about the teeter pin, under an operational loading of the propeller, as the propeller assembly spins on the propeller shaft.

7. A propeller stabilizer system comprising:
propeller assembly includes a hub, a plurality of propeller blades attached to the hub;
the hub mounted to a propeller shaft;
the hub connected to the propeller shaft with a teeter pin;
the teeter pin penetrates the propeller shaft at a right angle, perpendicular to the propeller shaft;
the propeller assembly tilt-able on the shaft, about the teeter pin;
the propeller shaft including a washer mount;
a conical washer element having an inside surface and an outside surface, the inside surface abutted to the propeller assembly and the outside surface abutted to the washer mount; and
the conical washer element for damping the tilt of the propeller assembly upon the propeller shaft, about the teeter pin, the propeller shaft terminates with a shaft nose; and
the conical washer element received onto the shaft nose.

8. The propeller stabilizer system of claim 7, wherein:
the conical washer element includes an inner conical washer abutted to the wear plate on one side and an outer conical washer on the other side of the inner conical washer.

9. The propeller stabilizer system of claim 7, wherein:
the conical washer element includes an inner conical washer abutted to an outer conical washer.

10. The propeller stabilizer system of claim 7, wherein:
the conical washer element includes a multiple of conical washers.

11. The propeller stabilizer system of claim 7, wherein:
the propeller system is a included in a wind machine.

12. The propeller stabilizer system of claim 7, wherein:
the conical washer element mechanically opposes the tendency of the propeller assembly to teeter about the teeter pin, under an operational loading of the propeller, as the propeller assembly spins on the propeller shaft.
